(19) United States
(12) Patent Application Publication
(10) Pub. No.: US 2019/0059240 A1
(43) Pub. Date: Feb. 28, 2019

(54) MODULAR PLANT GROWTH TRAY AND SUPPORT FENCING ASSEMBLY AND METHOD FOR SUPPORTING PLANT EXTREMITIES DURING GROWTH

(71) Applicant: JAK Projects, LLC, Grants Pass, OR (US)

(72) Inventors: Joshua M. Scott, Grants Pass, OR (US); Aimee Jeannette Jacobsen, Idleyld Park, OR (US); Kelley James Davis, Idleyld Park, OR (US)

(73) Assignee: JAK Projects, LLC, Grants Pass, OR (US)

(21) Appl. No.: 15/848,138

(22) Filed: Dec. 20, 2017

Related U.S. Application Data
(60) Provisional application No. 62/552,489, filed on Aug. 31, 2017.

(51) Int. Cl. A01G 9/02; A01G 9/12

(52) U.S. Cl. CPC A01G 9/022; A01G 27/00; A01G 9/028; A01G 9/12

(57) ABSTRACT

A modular plant growth and support fencing assembly and method for supporting plant extremities during growth of the plants which provides the dual function of containing a plant growth medium in a plant tray; and supporting the plant upper extremities through a framework of intersecting legs and ribs arranged at different heights. The plant tray contains soil growth medium, liquids, and plants. The tray has a generally convex bottom surface that causes the liquid to flow towards multiple drain holes at the depressed perimeter region. A pattern of cuboids and channels on the bottom surface of the tray facilitate drainage of liquid and enhance oxygenation of roots. A fence mounts above the plant tray that has intersecting legs, ribs, and connectors at predetermined levels along the height of the legs to fasten the plant upper extremities, i.e., stem, bud, and other parts of plant growing above the tray. The assembly can be assembled and disassembled through easy connection and disconnection of the tray to the legs, ribs, and connectors.

### CROSS-REFERENCE TO RELATED APPLICATIONS

This application claims priority from U.S. Provisional Application Ser. No. 62/552,489, entitled “Modular Plant Growth Tray and Support Fencing Assembly and Method for Supporting Plant Extremities During Growth”, filed on Aug. 31, 2017, which application is hereby incorporated herein by reference in its entirety.

### FIELD OF THE INVENTION

The present invention relates to a modular plant growth and support fencing assembly and method for supporting plant extremities during growth.

### BACKGROUND OF THE INVENTION

It is known that several efforts have been made extensively for a considerable period of time for use with flower pots for supporting plants like flower plants, vegetable plants or the like. For example the total weight of tomatoes on a tomato plant may prevent the stems and branches from growing straight and upright and eventually may cause damage by the breakage of the stems or branches, thus a support is needed for the plant to grow properly while without harming the parts of the plant. Many of the prior devices are supported in place by inserting the lower ends of a trellis-like structure into the soil within the pot. This is an unsatisfactory supporting arrangement, because the roots of the plants are frequently damaged when inserting the lower ends in place. Similarly, the roots are subsequently damaged when moving or handling the trellis-like structure. Further none of the prior art devices have been entirely satisfactory in fulfilling their intended purposes.

Numerous innovations have been provided in prior art that are adapted to support growing plants in a flower pot. Even though these innovations may be suitable for the specific purposes to which they address, however, they would not be as suitable for the purposes of the present invention.

For example, U.S. Pat. No. 199,353 to Clark discloses a summer-house or arbor formed of a series of uprights made of metal piping, connected by screw joints or connections or couplings.

U.S. Pat. No. 863,620 to Martens describes a flower support device to support plants in an upright position. The device is adapted to accommodate the size of box around and over which it is to be placed and provided with supports each having parallelly arranged wires and means for extending and shortening said wires and holding them taut.

U.S. Pat. No. 1,055,914 to Hus teaches a flower support comprising vertical posts, resilient clips upon the posts, hooks carried by the clips, frames adapted to be engaged by the hooks and each of the said frames having their outer end portions constructed of heavy wires.

U.S. Pat. No. 3,026,649 to Barakauskas discloses a plant support for a flower pot comprising a circular adjustable band clamp to fit onto the upper portion of the pot for holding the trellis by sockets which are circumferentially adjustable in position.

U.S. Pat. No. 4,841,670 to Bitter describes an apparatus for supporting plants comprising poles projecting from an annular base mounted on the top of a soil containing pot. Stems or branches of a plant are guided upwardly and within the space defined by the poles by means of strings tying the stems or branches securely around the poles.

U.S. Pat. No. 4,922,653 to Stone teaches a plant watering and feeding support system including at least three upstanding tubular stakes planted in a soil. A liquid poured in at least a top end of one of the stakes distributes the liquid to the other stakes through the distribution network and to the soil downwardly.

U.S. Pat. No. 5,862,625 to Parker describes an expandable water trellis comprising hollow pipes with linearly aligned water dispensers formed along a length thereof. A plurality of elastomeric stoppers and other mechanism are used to control the flow of water.

U.S. Pat. No. 6,609,333 to Warmerdam et al. teaches a detachable container lifting device that also facilitates the proper growth of plants and acts as a support structure such that breakage or bowing of the plant is substantially reduced or eliminated.

U.S. Pat. No. 6,944,989 to Bradley describes a system and kit of components for winterizing plants and trees, where the invention includes a generally skeletal frame formed by plural tubular members. The invention also includes a hydro heat transfer system that extracts the inherent heat from the ground and the heated air within the skeletal frame to provide additional protection against sub-freezing temperatures.

U.S. Pat. No. 7,017,299 to Speed et al. teaches a gardening cage having self-irrigating and self-fertilizing devices. Each panel of the cage includes panels include irrigating holes. Several cages can be connected side by side that branch off the supply hose and feed the individual cages via the water inlet fitting.

U.S. Pat. No. 7,685,765 to Stevenson, III discloses a plant support device including a base that connects to a supporting post that is formed from a series of axially connectable pole sections. The base may further include spacers capable of creating an aeration gap within the container.

U.S. Pat. No. 7,966,768 to DiPaolo et al. describes a staking system for use with a self-watering growing container includes an outrigger structure at each longitudinal end. Two vertical stakes are attached to respective outrigger structures and a horizontal stake element mounted between the two connectors.

U.S. Pat. No. 7,984,585 to Wu teaches a plant-weaving device comprising an outer receptacle that is capable of receiving a frame support that supports a variety of three-dimensional frames. Plants with long stems are prepared and inserted in the plant-weaving device, and are woven around and secured to the frame. After weaving, the plants may be stored or transported.

U.S. Pat. No. 8,186,101 to Kurtz discloses a planter apparatus for supporting plants having an upwardly open container with a sidewall, a wire planter cage frame supported on the sidewall, and clips releasably securing the planter cage frame to the container.

U.S. Pat. No. 8,567,120 to Davis et al. describes a modular plant support comprising a solid, cylindrical base with holes to accept posts and associate tier rings. A cover may also be provided to transform the base into a miniature hot house. Notches may be formed in the rim of the base to accommodate irrigation systems and stake ends may be provided for the posts to allow immediate securement of the posts to the ground rather than the base. As the plant grows, additional tiers may be added to the support to increase its size.

U.S. Pat. No. 8,857,103 to Coon teaches a planter with adjustable support stakes to support a growing houseplant, including a pot and length adjustable stakes each of which include at least one section rod having a bottom end inserted into a receptacle within a pot upper end and couplers which to vertically attach section rods together and a length of string attached to directly opposite couplers to prevent plant breakage and to support fruit produced by the houseplant.

U.S. Pat. No. 8,881,452 to Pacholyk et al. discloses a tomato tower with adjustable support trays. The device includes uprights, cross members, and supports. The supports are operatively and replaceably connected to the uprights, and replaceably support from the four orthogonal directions and from the varying heights the relocation of the tomatoes of the tomato plant from the lower elevations to the higher elevations as the tomato plant grows.

U.S. Pat. No. 8,925,246 to Stewart, Jr. describes a plant trellis system comprising a trellis base having a plurality of cutouts, a pot having a plurality of legs protruding from the bottom surface, and a plurality of wire mesh panels supported on the trellis base.

U.S. Patent Application No. 20020108303 to Layton. Jr. teaches a support for a branched plant includes an upper perimeter spaced apart by two or more spacers from a lower perimeter. The lower perimeter compression fits into a flower pot and the upper perimeter extends above the top edge of the pot. The upper perimeter provides support for the branches of a mature branched flower, holding them in such a way as to display them without either bunching them too tightly or allowing them to spread out too much.

U.S. Patent Application No. 20080263944 to McGaughey discloses a plant support having a base and a riser extending upward from the base. The base is received in a pot or the like and soil placed thereon to stabilize the base. The riser extends above the soil to support a plant growing in the soil.

U.S. Patent Application No. 20120090230 to Frost et al. describes a collapsible, expandable, configurable plant support apparatus having a plurality of panels having a planar configuration to accommodate use by a plant for support. The panels move individually to configure from a compact storage state to extend out to create support for a plant when in an expanded state and a closed state.

U.S. Patent Application No. 20150068117 to Savino teaches an adjustable plant cage comprising a plurality of vertical risers with a plurality of horizontal cross section assemblies that allow for vertical and horizontal adjustment for plant support.

U.S. Patent Application No. 20150101248 to Adkinson discloses a mesh lined planter box comprising a fabric mesh lined planter box comprising a base, a wire mesh panel attached to the base, a fabric mesh bag supported by the wire mesh panel, a trellis which includes vertically adjustable cross members and a watering system attached to the base unit, or trellis of the planter box.

U.S. Patent Application No. 20160135386 to Merz describes a plant growth support pot in which the support structure is built into the plant pot and the support structure comprises of pillars positioned in a plurality of pillar holders embedded the pot.

It is apparent now that numerous innovations for supporting plants in a flower pot have been developed in the prior art that are adequate for various purposes. Furthermore, even though these innovations may be suitable for the specific purposes to which they address, accordingly, they would not be suitable for the purposes of the present invention as heretofore described. Thus a modular plant growth and support fencing assembly to efficiently support the upper extremities of a plant, such as the buds, vines, or fruit while allowing draining excess liquid in the plant tray and providing additional space for the roots of the plant is needed.

### SUMMARY OF THE INVENTION

The present invention discloses a modular plant growth and support fencing assembly and method for supporting plant extremities during growth, wherein the assembly contains a plant growth medium in a segregated tray that is configured to enable facilitated drainage of liquid and enhanced oxygenation of roots; and supporting the plant upper extremities through a framework or lattice of intersecting legs and ribs arranged at different heights; whereby the plant tray contains a plant growing medium, liquid, and a plant for growth, and is defined by a generally convex shape that causes the liquid to flow towards multiple drain holes; and whereby a plurality of primary channels and plurality of secondary channels carry the liquid and create additional space for the roots; and the assembly further providing a multi-faceted fence that mounts above the plant tray and is defined by an open framework or lattice of intersecting legs and ribs that provide various heights to fasten the plant upper extremities, i.e., a stem, a bud, a vine, a stalk, a branch, and other parts of the plant growing above the top edge of the tray; whereby the tray and the multi-faceted fence are easily constructed and deconstructed through manual connection and disconnection of the tray to multiple pipes and connectors.

According to one aspect of the present invention a modular plant growth and support fencing assembly for containing a plant growing medium and liquids for growing a plant and providing support to the plant therein, the assembly includes an upwardly open tray, wherein the tray comprises a bottom surface having an elevated center region that is gradually sloped down towards a depressed perimeter region, the bottom surface further defined by a plurality of primary channels disposed to run at a predetermined distance to each other to form a plurality of square blocks on the bottom surface, wherein each of the square blocks comprises a plurality of cuboids separated by a plurality of secondary channels, thereby allowing extra liquid in the tray to drain out through a plurality of drain holes disposed at the perimeter region, and a sidewall extending from the perimeter region of the bottom surface to a top edge; a fence, wherein the fence comprises, a plurality of mount tubes arranged along the sidewall in a spaced apart relationship, a plurality of legs, each having a upper end and a mount end, wherein the mount end is connected to the mount tubes, a plurality of upper ribs connecting to the upper ends of the legs by a plurality of “L shaped” connectors, an upper connector wherein the upper connector defined by plurality of upper rib apertures, each rib aperture being sized and dimensioned to receive a respective upper rib forming a nexus at the upper connector, a plurality of transverse connectors defined by plurality of transverse connector apertures, a plurality of transverse ribs connecting two adjacent legs by the transverse connectors, thereby allowing a first set of adjacent transverse ribs to dispose a first plane and a second set of adjacent transverse ribs to dispose at a second plane along the height of the legs; and at least one fastening member detachably fastening the plant extremities to the fence.

According to another aspect of the present invention a method for supporting plant extremities during growth with a modular plant growth and support fencing assembly is described, the method includes filling a plant tray with a plant growing medium and a liquid; planting one or more plants on one or more square blocks formed on a bottom surface of the plant tray, wherein each of the square blocks are separated by a plurality of primary channels forming a checkerboard pattern on the bottom surface of the plant tray, whereby each of the square blocks comprises plurality of cuboids separated by a plurality of secondary channels allowing space for root growth of the one or more plants square blocks; draining the liquid through a plurality of drain holes, whereby a convex shape of the bottom surface of plant tray causes draining excess liquid to flow out through the plurality of drain holes; attaching eight legs to eight mount tubes in the plant tray; connecting upper ends of the eight legs with eight upper ribs by eight upper connectors; attaching one or more sets of eight transverse ribs at a predetermined height of the legs by one or more sets of eight transverse connectors; and detachably fastening, with at least one fastening member, the plant extremities to the legs, or the ribs, or both.

In view of the foregoing, it is therefore an object of the present invention to efficiently support the upper extremities of a plant, such as the buds, vines, or fruit.

Another objective is to provide transverse ribs at different levels along the height of the legs to support the different plant upper extremities.

Another objective is to drain excess liquid in the plant tray.

Another objective is to provide additional space for the roots of the plant.

Another objective is to enable fast assembling and disassembling of the tray, legs, and ribs for portability and storage.

Another objective is to provide an inexpensive to manufacture modular plant growth and support fencing assembly

Other objectives and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The invention will now be described, by way of example, with reference to the accompanying drawings, in which:

FIG. 1 illustrates a top perspective view of an exemplary modular plant growth and support fencing assembly, in accordance with an embodiment of the present invention;

FIG. 2 illustrates a side perspective view of an exemplary modular plant growth and support fencing assembly, in accordance with an embodiment of the present invention;

FIG. 3 illustrates a top view of an exemplary plant tray, highlighting the primary channels, secondary channels, a plurality of cuboids and a plurality of square blocks forming a checkerboard patterns, in accordance with an embodiment of the present invention;

FIG. 4 illustrates a top perspective view of a plant tray, highlighting the checkerboard pattern of the bottom surface, sidewalls, top edge and drainage holes of the tray, in accordance with an embodiment of the present invention;

FIG. 5 illustrates mounting a plurality of legs to a plurality of mount tubes attached to sidewall of the plant tray and a first set of ribs connected to the legs at a predetermined height, in accordance with an embodiment of the present invention;

FIG. 6A illustrates a close up view of an exemplary “L shaped” connector for connecting the upper ends of the legs to first ends of a plurality of upper ribs, in accordance with an embodiment of the present invention;

FIG. 6B illustrates a close up view of an exemplary upper connector for connecting second ends of the plurality of upper ribs to form a nexus at the top, in accordance with an embodiment of the present invention;

FIG. 7A illustrates a close up view of an exemplary transverse central connector for connecting the transverse ribs to legs at center at a predetermined height, in accordance with an embodiment of the present invention;

FIG. 7B illustrates a close up view of an exemplary transverse side connector for connecting the transverse ribs to legs at corners of the fence at the predetermined height, in accordance with an embodiment of the present invention; and

FIG. 8 illustrates a flowchart of an exemplary method for supporting plant extremities during growth of the plant, in accordance with an embodiment of the present invention.

Like reference numerals refer to like parts throughout the various views of the drawings.

### DETAILED DESCRIPTION OF THE INVENTION

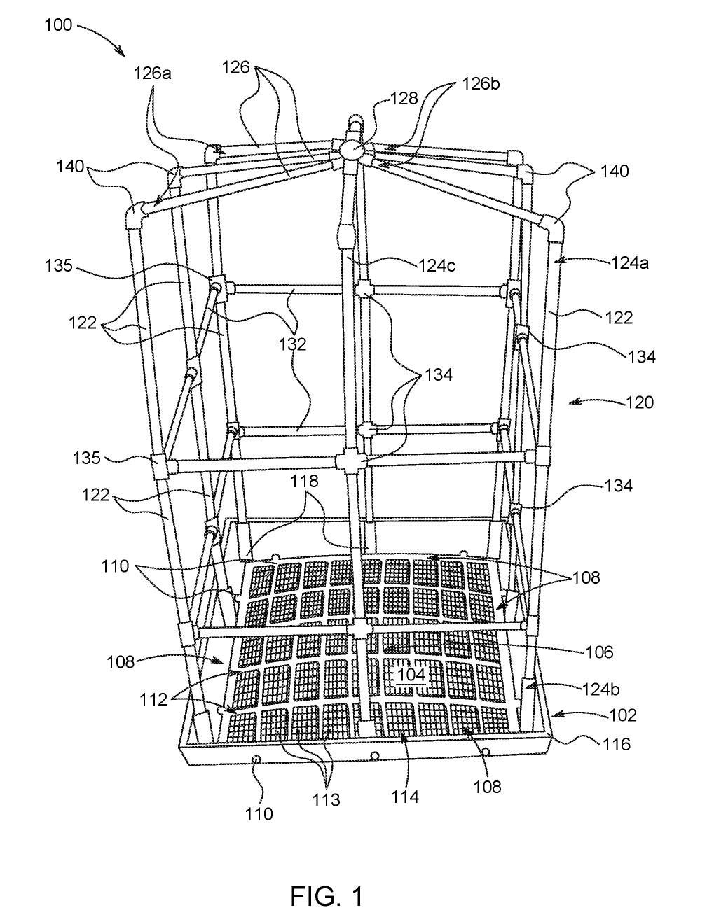

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A modular plant growth and support fencing assembly 100 and method 200 for supporting plant extremities during growth is referenced in FIGS. 1-8. The modular plant growth and support fencing assembly 100, hereafter “assembly 100” provides a plant tray 102 for containing a plant growth medium in the plant tray 102 that is filled with a soil growth medium, liquids for planting a plant on a checkerboard patterned surface that uses a plurality of cuboids 113 and channels 111, 112 to facilitate drainage of excess liquid and create enhanced oxygenation for roots. The assembly 100 also provides a fence 120 that mounts the plant tray 102 for supporting the plant upper extremities through a framework or lattice of intersecting legs 122 and ribs 126, 132 that traverse the legs 122 at one or more levels at different heights. The plant tray 102 and the fence 120 are easily assembled and disassembled for stowage and portability.

As referenced in FIG. 1, the plant tray 102 is configured to contain a plant growing medium and a plant growing liquid for efficient growth of a plant. The plant tray 102 is defined by a generally convex shaped bottom surface 104 having an elevated center region 106 and a lower perimeter region 108 that forms multiple drain holes 110. A plurality of square blocks 114 separated by primary channels 112, wherein each of the square blocks 114 comprises a plurality of cuboids 113 and secondary channels 111 formed on the bottom surface 104 of the plant tray 102 serve to: i) carry the excess liquid to the drain holes 110, ii) create additional space for the roots for enhanced oxygenation and space for growth, and iii) provide a visual checkerboard pattern to help in aligning the plants during planting. Preferably, the cuboids 113 are separated by the secondary channels 111, wherein the cuboids 113 are approximately one inch cubes.

The assembly 100 further provides a multi-faceted fence 120 that mounts on the plant tray 102 projected above the plant tray 102 to provide support to the plant extremities. The fence 120 is defined by an open framework or lattice of intersecting legs 122 and ribs 126, 132 that traverse the legs 122 at one or more levels at various heights to enable fastening of the plant upper extremities, i.e., a stem, a bud, a vine, a stalk, a branch at an appropriate height along the fence 120. The plant tray 102 and the fence 120 are fitted in a friction fit relationship to enable expedited and tool-free assembly and disassembly, although other known methods and devices to fit the legs 122 and ribs 126, 132 can be achieved without departing from the scope and the spirit of the present invention.

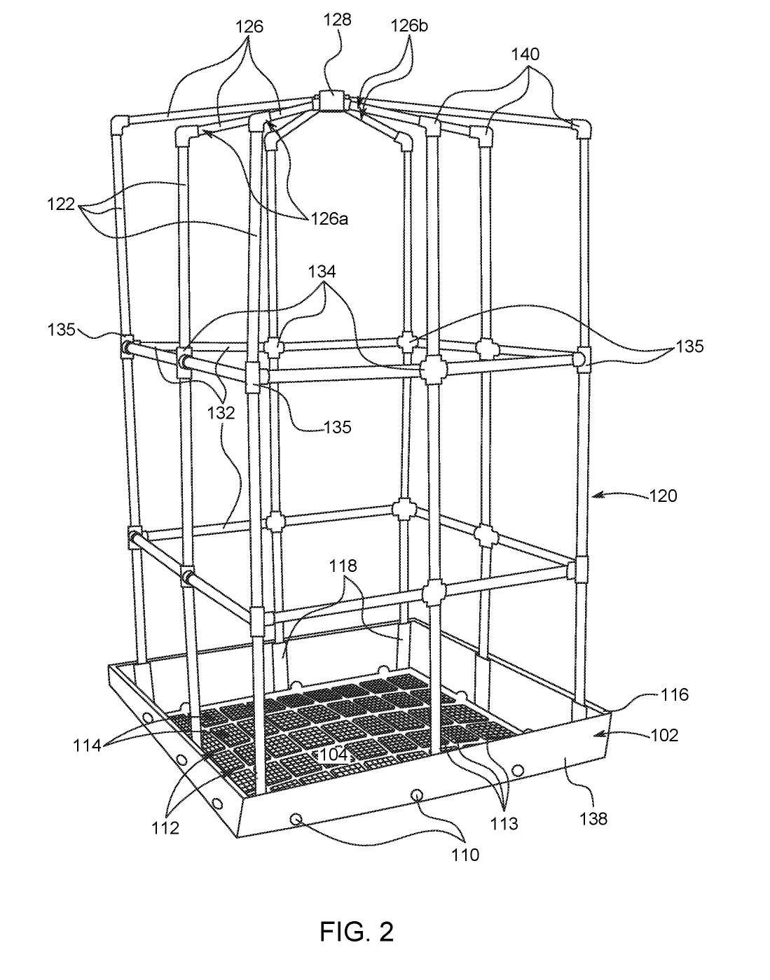

According to one aspect of a modular plant growth and support fencing assembly 100, the assembly 100 includes an upwardly open plant tray 102 for containing a plant growing medium, liquids, and one or more plants that are planted therein, the plant tray 102 having a bottom surface 104 defined by a generally convex shape forming an elevated center region 106 and a depressed perimeter region 108 forming multiple drainage holes 110, the bottom surface 104 further defined by a plurality of square blocks 114 separated by primary channels 112, wherein each of the square blocks comprises a plurality of cuboids 113 and secondary channels 111, the tray further having a sidewall 138 extending from the perimeter of the bottom surface 104 to a top edge 116; a plurality of mount tubes 118 arranged along the sidewall 138 in a spaced apart relationship; a fence 120 defined by an open framework of legs 122 and ribs 126, 132, the fence 120 comprising eight upwardly extending legs 122 arranged in spaced relationship with respect to one another, the legs 122 having upper ends 124a and mount ends 124b, whereby the fence 120 is receivable on the plant tray 102 with the mount ends of the legs respectively coupled to the mount tubes 118, the fence further comprising eight upper ribs 126 each having a first end 126b and a second end 126a, wherein second end 126a of each upper ribs 126 connects to the upper ends 124a of each of the legs 122, the upper ribs 126 forming a nexus at an upper connector 128, the upper connector 128 defined by eight upper rib apertures 130, each rib aperture being sized and dimensioned to receive the first end 126b of respective upper rib 126 to form a conical structure at the top of the fence 120, the fence 120 further comprising eight transverse ribs 132 extending between two adjacent legs to thereby join the legs 122, whereby adjacent transverse ribs 132 are disposed at same level along the height of the legs 122, whereby each set of the eight transverse ribs 132 are arranged at same level along the height of the legs 122, further a plurality of sets of transverse ribs 132 can be attached at different levels along the height of the legs 122 for providing a surface to detachably fasten the plant extremities at different heights, each set of the transverse ribs 132 joining the legs 122 at least eight transverse connectors 134, 135. Although an exemplary arrangement as shown in at least FIGS. 1 and 2, at least sixteen transverse connectors 134, 135 are used to attach two sets, i.e., sixteen transverse ribs 132 at different levels along the height of the legs 122 of the fence 120, the transverse connectors 134, 135 defined by transverse connectors 134, 135 four transverse connector apertures 134a-d, 135a-d as illustrated in FIG. 7A-B, each transverse connector aperture 134a-b, 135a-b being sized and dimensioned to receive a respective transverse rib 132, whereby each transverse rib 132 connects with two adjacent legs 122 by two transverse connectors 134, 135; and at least one fastening member detachably fastening the plant extremities to the legs, or the ribs, or both. Other arrangements known in the prior art can, however, be used to dispose transverse ribs 132 at different levels along the height of the legs 122 of the fence 120 without departing from the scope and the spirit of the present invention.

In another exemplary embodiment of the invention, the transverse connectors 134, 135 comprises central transverse connectors 134 and side transverse connectors 135 defined by four transverse connector apertures 134a-d and 135a-d respectively as illustrated in FIG. 7A-B. The central transverse connectors 134 are connected to the legs at the center of the fence 120 connecting the transverse ribs 132 and the side transverse connectors 135 are connected to the legs at the corner of the fence 120 connecting the transverse ribs 132.

In another aspect a modular plant growth and support fencing assembly 100 for containing a plant growing medium and liquids for growing one or more plants and providing support to the plants therein, the assembly 100 comprises an upwardly open tray 102, wherein the tray 102 including a bottom surface 104 having an elevated center region 106 that is gradually sloped down towards a depressed perimeter region 108, the bottom surface 104 further defined by a plurality of primary channels 112 disposed to run at a predetermined distance to each other to form a plurality of square blocks 114 on the bottom surface 104 to form a checkerboard pattern, wherein each of the square blocks 114 comprises plurality of cuboids 113 separated by a plurality of secondary channels 111, thereby allowing extra liquid in the tray 102 to drain out through a plurality of drain holes 110 disposed at the perimeter region 108, and a sidewall 138 extending from the perimeter region 108 of the bottom surface 104 to a top edge 116; a fence 120, wherein the fence 120 comprising: eight mount tubes 118 arranged along the sidewall in a spaced apart relationship, eight number of legs 122, each having a upper end 124a and a mount end 124b, wherein the mount ends 124b of the legs 122 are connected to the respective eight mount tubes 118, eight upper ribs 126 connecting to the upper ends 124a of the legs 122 by eight numbers of “L shaped” connectors 140, an upper connector 128 wherein the upper connector 128 is defined by eight upper rib apertures 130 sloped downward at a desired angle, each rib aperture 130 being sized and dimensioned to receive the respective upper rib 126 forming a nexus at the upper connector 128 to form a conical structure at the top of the fence 120, at least eight transverse connectors 134, 135 defined by four transverse connector apertures 134a-d and 135a-d on each transverse connectors 134, 135, at least eight transverse ribs 132, wherein each rib 132 connecting two adjacent legs 122 by two transverse connectors 134, 135, wherein each transverse connector aperture 134a-d and 135a-d being sized and dimensioned to receive transverse ribs 132 and legs 122, thereby allowing adjacent transverse ribs 132 to dispose at same level along the height of the legs 122; and at least one fastening member (not shown) detachably fastening the plant extremities to the fence 120.

In another preferred embodiment of the invention, a method 200 for supporting plant extremities during growth with a modular plant growth and support fencing assembly 100 is described, the method 200 comprises step 202 of filling a plant tray with a plant growing medium and a liquid; step 204 of planting one or more plants on one or more square blocks formed on a bottom surface of the plant tray, wherein each of the square blocks are separated by a plurality of primary channels forming a checkerboard pattern on the bottom surface of the plant tray, whereby each of the square blocks comprises a plurality of cuboids separated by a plurality of secondary channels allowing space for root growth of the one or more plants on the square blocks; step 206 of draining the liquid through a plurality of drain holes, whereby a convex shape of the bottom surface of plant tray causes draining excess liquid to flow out through the plurality of drain holes; step 208 of attaching eight legs to eight mount tubes in the plant tray; step 210 of connecting upper ends of the legs with eight upper ribs by eight upper connectors extending form a transverse central connector for joining the legs with the upper ribs to form a conical structure at the top of the fence; step 212 of attaching one or more sets of eight transverse ribs at a predetermined height of the legs by one or more sets of eight transverse connectors; and detachably fastening, with at least one fastening member, the plant extremities to the legs, or the ribs, or both.

In another aspect, the plant tray 102 has a generally square shape for individual plant use or rectangular shape for multiple plant use. Other shapes of a plant tray can, however, be used without departing from the scope and spirit of the present invention.

In another aspect, the plant tray 102 is constructed from a rigid polymer.

In another aspect, the legs 122 and the ribs 126, 132 are PVC pipes.

In another aspect, the square blocks 114 forms a crisscross checker pattern on the bottom surface 104 of the tray 102.

In another aspect, the multiple drain holes 110 comprise at least three drain holes 110 on each side of tray and at least eight drain holes disposed at the perimeter region of the tray, although any number of drain holes can be used without departing from the scope and spirit of the present invention.

In another aspect, the plant is medical cannabis and a vine plant.

In another aspect, the plant extremities comprise a stem, a bud, a vine, a stalk, a branch, and other parts of the plant growing above the top edge 116 of the plant tray 102.

In another aspect, the transverse connectors 134, 135 are defined by a “+” shape or the like.

One objective of the present invention is to efficiently support the upper extremities of a plant, such as the buds, vines, or fruit.

Another objective is to provide ribs 126, 132 at different heights to support the different plant upper extremities.

Another objective is to drain excess liquid out of the plant tray 102.

Yet another objective is to provide additional space for the roots of the plant.

Yet another objective is to enable fast assembling and disassembling of the tray 102, legs 122, and ribs 126, 132 for portability and storage.

Yet another objective is to provide an inexpensive to manufacture modular plant growth and support fencing assembly 100.

Those skilled in the art will recognize that plant containers for live goods, such as medical cannabis and vined plants, come in many shapes and sizes and are made from a number of different materials, such as clay, terra cotta and more recently, plastics. For climbing plants, or tall, stemmed live goods such as medical cannabis buds and tomato plants that can become top-heavy as they mature, a stake or other type of rod is generally inserted in soil in the container to provide support. When numerous buds on the medical cannabis form, vertical stakes are, however, insufficient to carry all of the buds or vines. Further inserting the rods or the like into the soil within the pot is an unsatisfactory supporting arrangement, because the roots of the plants are frequently damaged when inserting the rods in place. Similarly, the roots are subsequently damaged when moving or handling the rod like structure.

It is also recognized that a major problem associated with growing plants, and in particular medical cannabis and taller vined plants, is the lack of support above the pot/tray to hold the vines, stalks, or other parts of the plant as they grow above the top of the pot. Frequently, these upper portions of the plant are the most valuable as they contain the fruits, vegetables, or flowers which the grower desires to eventually harvest. These valuable portions of the plants must be exposed to sufficient sunlight, and simultaneously provided with support so that they do not bend and either break or hang down to areas exposed to less sunshine or where they will contact undesirable surfaces and thus stunt the growth and production of the desired products.

FIG. 2 illustrates a perspective view of the assembly 100, showing an upwardly open plant tray 102 for containing a plant growing medium, liquids, and a plant that is planted therein. The plant is rooted inside the plant tray 102 amongst the plant growing medium, which may include soil, fertilizer, and other nutrients; and a liquid, such as a liquid plant nutrient solution known in the art of horticulture or floriculture or the like. The plant tray 102 is lightweight and sufficiently sturdy to withstand movement and filling with soil and plant liquid nutrients. A user can easily carry the plant tray 102 due to its lightweight structure.

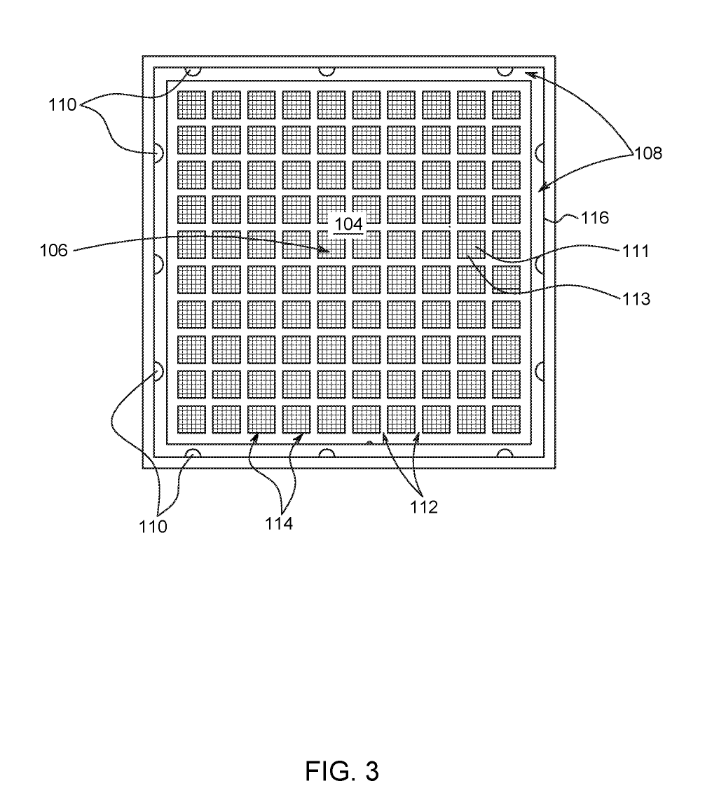

In one non-limiting embodiment as shown in FIG. 3, the plant tray 102 has a bottom surface 104 that is defined by a generally convex shape. The convex shape forms an elevated center region 106 and a depressed perimeter region 108 of the bottom surface 104. The perimeter region 108 forms multiple drainage holes 110. The drainage hole 110 is sized and dimensioned to enable passage of the liquid or other debris to outside of the plant tray 102. This drainage capacity helps prevent excess liquid from stagnating in the soil and roots, which can cause problems for the plant, such as root rot and other plant diseases.

The bottom surface 104 of the plant tray 102 is further defined by a plurality of primary channels 112 that are disposed to run at a predetermined distance to each other to form a plurality of square blocks 114 on the bottom surface 104. The square blocks 114 and the primary channels 112 generally run parallel to each other, and may also form a perpendicular arrangement. This creates a checkerboard pattern that allows a user to align plant during planting more easily. Thus, the user can align the plants for optimal spacing and growth conditions.

FIG. 3 is a top view of an exemplary plant tray, highlighting the primary channels 112, secondary channels 111, a plurality of cuboids 113 and a plurality of square blocks 114 forming a checkerboard pattern on the bottom surface 104 of the tray 102, in accordance with an embodiment of the present invention. The primary channels 111 surrounds each of the plurality of square blocks 114 facilitating drainage of excess liquid from the square blocks 114 to the drainage holes 110 via the primary channels 112 from the bottom surface 104 of the tray 102. The arrangement of the square blocks 114 and the primary channels 112 form the checkerboard pattern on the bottom surface 104 of the tray 102. Further each of the square blocks 114 comprises a plurality of cuboids 113 and secondary channels 111 formed on the bottom surface 104 of the plant tray 102. Thus the square blocks 114 provide extra space and oxygenation for the roots, which helps to enhance growth of the plant. The square blocks 114 also help in alignment and plant positioning on the bottom surface 104 of the plant tray 102.

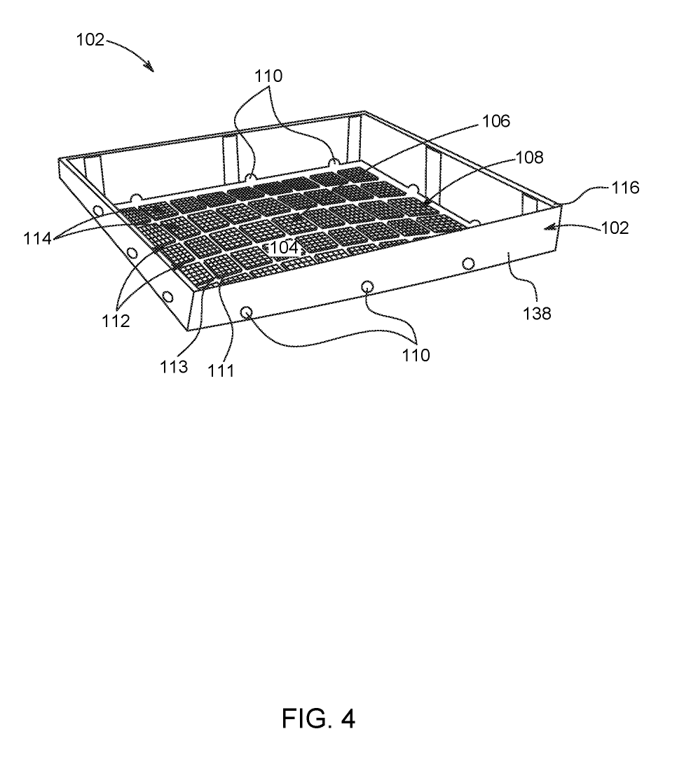

FIG. 4 illustrates the plant tray 102 may further include a sidewall 138 that extends from the perimeter of the bottom surface 104 to a top edge 116 that forms at the terminus of the sidewall 138. A plurality of mount tubes 118 are attached to the inner surface of the sidewall 138 in a spaced apart relationship. The mount tubes 118 receive legs of the fence to create a modular assembly 100 that can easily be attached and detached by a single user portability and stowage.

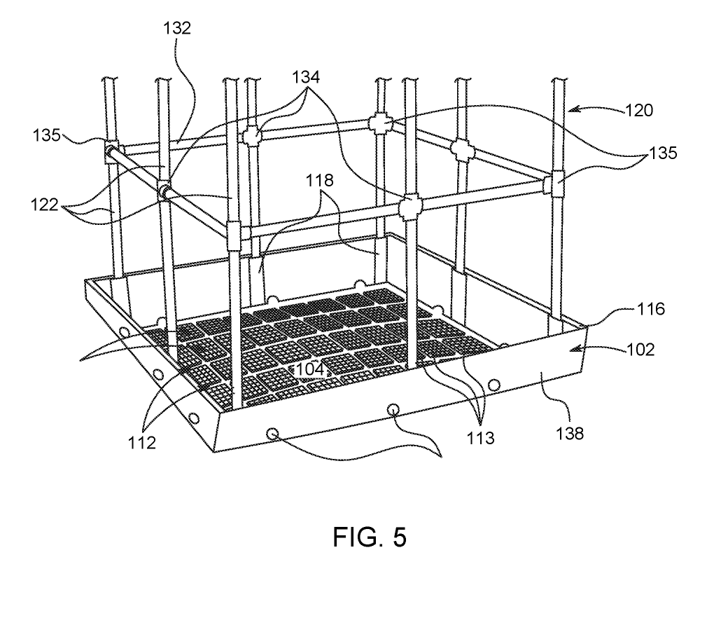

Turning to FIG. 5, the assembly 100 further comprises a multi-faceted fence 120 that serves primarily as a supportive lattice for the upper extremities of the plant. The fence 120 is defined by an open framework of intersecting legs 122 and ribs 126, 132. The fence 120 comprises eight downwardly extending legs 122 arranged in spaced relationship with respect to one another. The downwardly extending legs 122 having upper ends 124a and mount ends 124b. The fence 120 is receivable on the plant tray 102 with the mount ends 124b of the legs 122 coupled to a corresponding mount tube 118. The legs 122 extend from the tray, upwardly to a predetermined height, depending on the potential height of the plant, or the height of the user to access the uppermost point of the legs 122. As shown in FIGS. 1 and 2, eight legs 122 are used to form the fence 120 around the tray 102. In other embodiments a greater or lesser number of legs may, however, also be used without departing from the scope and spirit of the present invention. This is because the assembly 100 is scalable to accommodate variously sized and types of plants.

In one possible embodiment, the legs 122 include any elongated member that is flexible and sufficiently rigid to support the weight of the plant upper extremities. In another embodiment, the legs 122 are pipes. The material of the pipes may include plastics. In the preferred embodiment the preferred material is PVC tubing and fittings. PVC is, however, recognized by those of ordinary skill in the tubing arts to also be a material which is satisfactory for use. It will be appreciated by those of ordinary skill in tube arts that a bushing may be required to mate the outer tube, inner tube with a tubular cross, or connector. Any lightweight material known in the art of horticulture, floriculture, or the like may, however, also be used.

In some embodiments, the fence 120 further comprises eight upper ribs 126 that form of the most elevated portion of the fence 120. The upper ribs 126 extend radially from a central point at the apex of the fence 120. One end of each upper rib 126 connects to a respective upper end of a leg 122.

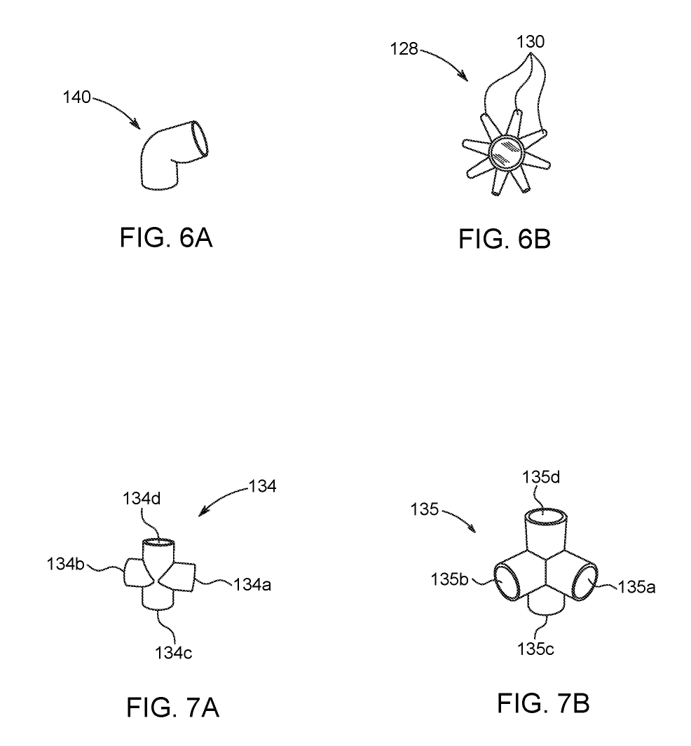

As shown in FIG. 6B, an upper connector 128 that ties all of the ribs 126 at the apex of the fence 120 to form a nexus at the top, whereby each of the ribs 126 having a first end 126b and a second end 126a, wherein second end 126a of each upper ribs 126 are connected to the upper ends 124a of the respective legs 122 by a “L shaped” connector 140 as shown in FIG. 6A. The upper connector 128 is defined by eight upper rib apertures 130, with each rib aperture 130 being sized and dimensioned to receive a respective first end 126b of an upper rib 126. In one embodiment the rib apertures 130 of the upper connector 128 are circular and shaped and slightly larger in circumference than the ends 126b of the ribs 126 so as to create a friction fit relationship there between. Further as shown in FIGS. 1, 2, 6A, and 6B, the rib apertures 130 of the upper connector 128 are sloped downward at a desired angle and the “L shaped” connectors 140 are sloped upward at a desired angle. This allows the upper ribs 126 to form a conical structure at the top of the fence 120 for covering at least the upper portion of the fence 120 by any suitable material such as polythene sheets or the like to act as an umbrella to drain off rain water, thus protecting the plants from being damaged by heavy rainfall. According to an exemplary embodiment of the present invention the upper connector 128 is positioned at a height at least 6 inches above the upper ends 124a of the legs 122.

In some embodiments, the fence 120 also includes eight transverse ribs 132 that extend between each two adjacent downwardly extending legs. The transverse ribs 132 are configured to join the eight downwardly extending legs 122. The transverse ribs 132 are, attached to the legs 122 at several predetermined heights to form a support structure to the fence 120 as well as support the plant extremities during different stages of growth. In this manner, the upper plant extremities can be tied to a first set of transverse ribs 132 at lower most level of the fence 120 during the early stage of the growth of the plant, while at a later stage of the growth of the plant, the plant extremities can be tied to a second set of transverse ribs 131 at an upper level of the fence 120 below the upper ribs 126. As shown in FIGS. 1 and 2, eight upper ribs 126 and two sets of eight transverse ribs 132 are used to make the fence 120. In other embodiments a greater or lesser number of ribs may, however, also be used. This is because the assembly 100 is scalable to accommodate variously sized and types of plants.

In an exemplary embodiment, the eight transverse ribs 132 join the downwardly extending legs at eight transverse connectors 134, 135. Two sets of transverse ribs 132, i.e., sixteen transverse ribs 132 join the downwardly extending legs at sixteen transverse connectors 134, 135 as shown in FIGS. 1 and 2. The transverse connectors 134, 135 are defined by four transverse connector apertures 134a-d, 135a-d according to an embodiment of the present invention. In an exemplary embodiment as shown in FIG. 7, the transverse connectors 134, 135 comprises central transverse connectors 134 and side transverse connectors 135 defined by four transverse connector apertures 134a-d and 135a-d respectively. Two transverse connector apertures 134a-b, 135a-b are sized and dimensioned to receive a respective transverse rib; and two transverse connector apertures 134c-d, 135c-d are sized and dimensioned to receive a respective section of legs 122. In one embodiment the transverse connector apertures 134a-d, 135a-d of the transverse connectors 134, 135 are circular and shaped and slightly larger in circumference than the ends of the legs 122 and the ends of the transverse ribs 132 so as to create a friction fit relationship there between. Thus, each transverse rib 132 connects with two adjacent downwardly extending legs at two transverse connectors 134, 135 in a friction fit relationship that allows for easy attachment and detachment.

In some embodiments at least one fastening member (not shown) detachably attaches the plant extremities to the legs 122, or the ribs 132, or both. The fastening member is configured to enable quick fastening, so that adjustments can be made as the plant grows, or as other parts of the plant extremities become crowded together and require rearrangement on different legs 122 and ribs 132. The fastening member may include, without limitation, a string, a tie, a clamp, and any tying mechanism known in the art of horticulture.

In operation, the plant tray 102 is filled with a soil and the plants are planted in a spaced apart relationship based partially on the visual confirmation of the cuboids 113, the square blocks 114, the primary channel 112 and the secondary channels 111. Thus, the square blocks 114 help the user align the plants for optimal spacing and growth conditions. A liquid, such as water or other nutrient solution is added to the soil to enable plant growth. The drain hole 110 is checked frequently to make sure it is not plugged, so that proper drainage is allowed.

As shown in FIG. 5, the fence 120 is assembled by connecting the mount ends 124b of the legs 122 to mount tubes 118 that form in the plant tray 102. This is accomplished through a friction fit connectivity means upper ribs 126 are used upper ends 124a of the legs 122 together and an upper connector 128 creates a secure junction point. At this point of the assembly 100, the legs 122 reinforce the ribs by an “L shaped” connector 140 and the upper connector 128 reinforces other ends of the ribs 126 to strengthen the overall connection. Each of the ribs 126 having a first end 126b and a second end 126a, wherein second end 126a of each upper ribs 126 are connected to the upper ends 124a of the respective legs 122 by the “L shaped” connector 140. To provide additional points a fastening for the plant extremities, and to increase the structural integrity of the fence 120, transverse ribs 132 are connected to the legs 122 at a predetermined height. Transverse connectors 134, 135 are used to connect the transverse ribs 132 to the legs 122 at different levels depending on the growth of the plant.

As the plant grows to a specific height, the plant extremities, which may include buds, lines, or fruit, began to droop. A user ties the plant extremities to a leg or a rib report during growth. By tying the plant extremities in this manner, the user can more easily access the plant extremity without having to step in the midst of the plants.

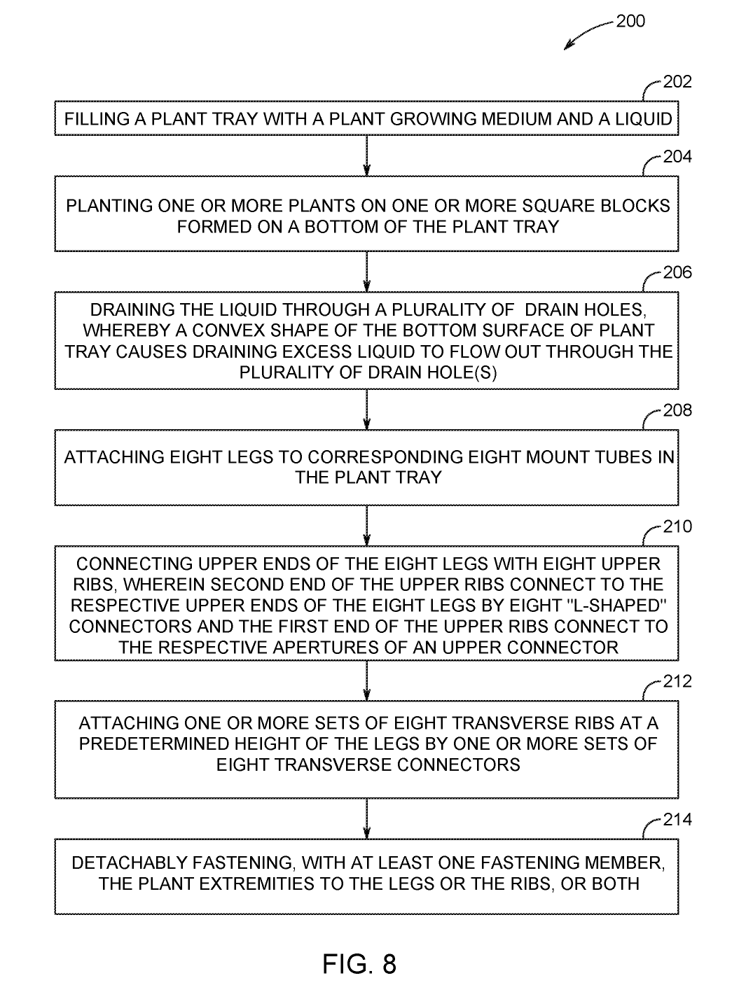

FIG. 8 references a flowchart of an exemplary method 200 for supporting plant extremities during growth with a modular plant growth and support fencing assembly 100. The method 200 may include an initial Step 202 of filling a plant tray 102 with a plant growing medium and a liquid. The method 200 may further comprise a Step 204 of planting one or more plants on one or more square blocks 114 formed on a bottom surface 104 of the plant tray 102, wherein each of the square blocks 114 are separated by a plurality of primary channels 112 forming a checkerboard pattern on the bottom surface 104 of the plant tray 102, whereby each of the square blocks 114 comprises plurality of cuboids 113 separated by a plurality of secondary channels 111 allowing space for root growth of the one or more plants the square blocks 114. A Step 206 includes draining the liquid through multiple drain holes, whereby a convex shape of the bottom surface 104 of plant tray 102 causes draining excess liquid to flow out of the tray 102 through the plurality of drain holes 110.

In some embodiments, a Step 208 may include attaching a plurality of legs 122 to a plurality of mount tubes in the plant tray 102. A Step 210 includes connecting upper ends 124a of the plurality of legs 122 with a plurality of upper ribs 126 by a plurality of “L shaped” connectors 140 to their second ends 126a, whereby the upper connector 128 forms a junction for joining the first ends 126b of the upper ribs 126 to form a conical structure at the top of the fence. In some embodiments, a Step 212 may include attaching one or more sets of a plurality of transverse ribs 132 around the legs one or more predetermined levels, whereby a plurality of transverse connectors 134, 135 forming a junction for joining the legs 122 with the transverse ribs 132. A final Step 214 comprises detachably fastening, with at least one fastening member, the plant extremities to the legs 122, or the ribs 126, 132, or both.

The present invention has many advantages including that the modular plant growth and support fencing assembly 100 is designed to be set anywhere, including out on the ground because poles connect direct into the tray 102; thereby making it useable anywhere. Also, the assembly 100 has a top to it. The plant tray 102 is also configured to hold plants straight up and down, giving them more sunlight and more area for the side buds to spread out. Also, the fencing 120 is interlocking without the need for clips. The fencing 120 is an all-in-one component. The assembly is also intended to be used indoors or outdoors. Further the assembly 100 can be used as a “bag plant unit” where the user may put a tree already bagged in the middle of the tray 102 and then place a fence 120 around it, or the tray 102 itself may be used as the dirt holder and grow the plant from seed to flower.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A modular plant growth and support fencing assembly for containing plant growing medium and liquids for growing plants and providing support to the plants therein, the assembly comprising:
an upwardly open tray, wherein the tray comprises:
a bottom surface having an elevated center region that is gradually sloped down towards a depressed perimeter region, the bottom surface further defined by a plurality of primary channels disposed to run at a predetermined distance to each other to form a plurality of square blocks on the bottom surface, wherein each of the square blocks comprises a plurality of cuboids separated by a plurality of secondary channels, thereby allowing extra liquid in the tray to drain out through a plurality of drain holes disposed at the perimeter region, and
a sidewall extending from the perimeter region of the bottom surface to a top edge;
a fence, wherein the fence comprises:
a plurality of mount tubes arranged along the sidewall in a spaced apart relationship,
a plurality of legs, each having a upper end and a mount end, wherein the mount end is connected to the mount tubes,
a plurality of upper ribs connecting to the upper ends of the legs by a plurality of L-shaped connectors,
an upper connector wherein the upper connector defined by plurality of upper rib apertures, each rib aperture being sized and dimensioned to receive a respective upper rib forming a nexus at the upper connector,
a plurality of transverse connectors defined by plurality of transverse connector apertures,
a plurality of transverse ribs connecting two adjacent legs by the transverse connectors, thereby allowing a first set of adjacent transverse ribs to dispose at a first plane and a second set of adjacent transverse ribs to dispose at a second plane along the height of the legs; and
at least one fastening member detachably fastening the plant extremities to the fence.

2. The assembly of claim 1, wherein the plurality of square blocks on the bottom surface forms a crisscross checkerboard pattern.

3. The assembly of claim 1, wherein the tray is of rectangular shape and comprises at least three drain holes on each side of rectangular shape of the tray.

4. The assembly of claim 1, wherein the plurality of legs comprises at least eight legs mounted on eight mount tubes on the sidewall of the tray.

5. The assembly of claim 1, wherein the plant tray is constructed from a rigid polymer.

6. The assembly of claim 1, wherein the ribs comprise PVC pipes.

7. The assembly of claim 1, wherein the upper connector comprises eight upper rib apertures to receive eight upper ribs.

8. A modular plant growth and support fencing assembly for containing a plant growing medium and liquids for growing a plant and providing support to the plant therein, the assembly comprising:
an upwardly open tray, wherein the tray comprises:
a bottom surface having an elevated center region that is gradually sloped down towards a depressed perimeter region, the bottom surface further defined by a plurality of primary channels disposed to run at a predetermined distance to each other to form a plurality of square blocks on the bottom surface to form a checkerboard pattern, wherein each of the square blocks comprises a plurality of cuboids separated by a plurality of secondary channels, thereby allowing extra liquid in the tray to drain out through a plurality of drain holes disposed at the perimeter region, and
a sidewall extending from the perimeter region of the bottom surface to a top edge;
a fence, wherein the fence comprises:
a plurality of mount tubes arranged along the sidewall in a spaced apart relationship,
a plurality of legs, each having a upper end and a mount end, wherein the mount ends of the legs are connected to the respective eight mount tubes,
eight upper ribs connecting to the upper ends of the legs by eight numbers of L-shaped connectors,
an upper connector wherein the upper connector defined by eight upper rib apertures, each rib aperture being sized and dimensioned to receive the respective upper rib forming a nexus at the upper connector,
at least eight transverse connectors defined by at least four transverse connector apertures on each transverse connector,
at least eight transverse ribs, wherein each rib connecting two adjacent legs by the transverse connectors, wherein each transverse connector aperture being sized and dimensioned to receive transverse ribs and legs, thereby allowing adjacent transverse ribs to dispose at same level along the height of the legs; and
at least one fastening member detachably fastening the plant extremities to the fence.

9. The assembly of claim 8, wherein the plant tray has a generally square shape for individual plant use.

10. The assembly of claim 8, wherein the plant tray has a generally rectangular shape for multiple plant use.

11. The assembly of claim 8, wherein the plant tray is constructed from a rigid polymer.

12. The assembly of claim 8, wherein the ribs and legs comprise PVC pipes.

13. The assembly of claim 8, wherein the multiple drain holes comprises at least eight drain holes disposed at the perimeter region of the tray.

14. The assembly of claim 8, wherein the transverse connectors are defined by a “+”-shape.

15. A method for supporting plant extremities during growth with a modular plant growth and support fencing assembly, the method comprising:
filling a plant tray with a plant growing medium and a liquid;
planting one or more plants on one or more square blocks formed on a bottom surface of the plant tray, wherein each of the square blocks are separated by a plurality of primary channels forming a checkerboard pattern on the bottom surface of the plant tray, whereby each of the square blocks comprises a plurality of cuboids separated by a plurality of secondary channels allowing space for root growth of the one or more plants the square blocks;
draining the liquid through a plurality of drain holes, whereby a convex shape of the bottom surface of plant tray causes draining excess liquid to flow out through the plurality of drain holes;
attaching a plurality of legs to a plurality of mount tubes in the plant tray;
connecting upper ends of the plurality of legs with a plurality of upper ribs, wherein second end of the plurality of upper ribs connect to the respective upper ends of the plurality of legs by a plurality of L-shaped connectors and the first end of the plurality of upper ribs connect to the respective apertures of a upper connector to form a conical structure at the top of the fence;
attaching one or more sets of a plurality of transverse ribs at a predetermined levels along the height of the plurality of legs by one or more sets of a plurality of transverse connectors; and
detachably fastening with at least one fastening member, the plant extremities to the plurality of legs, or the plurality of ribs, or both.

16. The method of claim 15, wherein the plant tray has a generally square shape for individual plant use or rectangular shape for multiple plant use.

17. The method of claim 15, wherein at least eight upper ribs are attached to upper ends of eight legs by eight L-shaped connectors.

18. The method of claim 15, wherein the plant extremities comprise a stem, a bud, a vine, a stalk, a branch, and other parts of the plant growing above the tray.

19. The method of claim 15, wherein at least two sets of eight transverse ribs are attached to adjacent legs by eight transverse connectors at different heights of the legs allowing the upper plant extremities can be tied at different elevations along the fence.

20. The method of claim 15, wherein each of the square blocks allow positioning at least one plant, wherein the plurality of cuboids are separated by a plurality of secondary channels allowing proper root growth of the at least one plant, further the secondary channels allow excess water to drain to primary channels and thereby drain out of the tray through the plurality of drain holes.
